(19) United States
(12) Patent Application Publication
(10) Pub. No.: US 2025/0244561 A1
(43) Pub. Date: Jul. 31, 2025

(54) PROJECTION OPTICS AND METHOD FOR MANUFACTURING AN OPTICAL STRUCTURE

(71) Applicant: OptaSensor GmbH, Nuernberg (DE)

(72) Inventors: Antonio Jose DE MATOS GOMES, Nuernberg (DE); Stephan VOLTZ, Happurg (DE)

(21) Appl. No.: 19/065,864

(22) Filed: Feb. 27, 2025

Related U.S. Application Data
(63) Continuation of application No. PCT/EP2023/073721, filed on Aug. 29, 2023.

(30) Foreign Application Priority Data
Aug. 29, 2022 (DE) 10 2022 208 949.9

(51) Int. Cl. G02B 13/00

(52) U.S. Cl. CPC G02B 13/002

(57) ABSTRACT

Embodiments according to the invention comprise a method for manufacturing an optical structure, wherein the method comprises forming a first layer of the optical structure, wherein forming the first layer comprises forming and curing a first curable material on a first molding structure in order to form the first layer, so that, at a first side of the first layer, at which the first layer joins the first molding structure, a first optical lens surface is formed. The method further comprises providing a second layer of the optical structure at a second side, opposite to the first side, of the first layer, while the first layer joins the first molding structure at the first side of the first layer. Further embodiments according to the invention comprise projection optics.

### CROSS-REFERENCE TO RELATED APPLICATIONS

This application is a continuation of copending International Application No. PCT/EP2023/073721, filed Aug. 29, 2023, which is incorporated herein by reference in its entirety, and additionally claims priority from German Application No. 10 2022 208 949.9, filed Aug. 29, 2022, which is also incorporated herein by reference in its entirety.

Embodiments according to the invention are related to projection optics and methods for manufacturing optical structures.

### BACKGROUND OF THE INVENTION

Modern camera systems face ever increasing demands for miniaturization, higher performance, and reduction of costs. As an example, for medical applications, camera systems may have to fulfil strict constraints with regard to their dimensioning, in order to be suitable for medical purposes wherein the camera system is inserted in the human body, in order to support surgery or to decide on the next steps for a respective treatment. Despite these constraints, it may be important that the small camera system is able to provide high quality images, in order to provide the best possible support for the treating physician. At the same time, there is a need to provide such systems with low complexity manufacturing methods in order to keep the costs low.

Therefore, it is desired to get a concept for an optical structure and for a manufacturing thereof as well as projection optics, which makes a better compromise between a size, a performance and a complexity and hence costs of the optical structure or projection optics respectively and the respective manufacturing thereof.

### SUMMARY

According to an embodiment, projection optics may have: a first layer of a first cured material, wherein the first layer comprises a first optical lens surface at a first side of the first layer at an optical axis of the projection optics, and wherein the first layer comprises a planar portion at a second side of the first layer, opposite to the first side of the first layer, at the optical axis; and a second layer of a second cured material, wherein the second layer comprises a planar portion at a first side of the second layer at the optical axis, and wherein the second layer comprises a second optical lens surface at a second side of the second layer, opposite to the first side of the second layer, at the optical axis; wherein the planar portion of the first layer adjoins the planar portion of the second layer at the optical axis, or wherein the planar portion of the first layer is separated from the planar portion of the second layer at the optical axis, only by one or more coating layers.

According to another embodiment, a method for manufacturing an optical structure may have the steps of: forming a first layer of the optical structure, wherein forming the first layer comprises forming and curing a first curable material on a first molding structure in order to form the first layer, so that, at a first side of the first layer, at which the first layer adjoins the first molding structure, a first optical lens surface is formed; and providing a second layer of the optical structure at a second side, opposite to the first side, of the first layer, while the first layer adjoins the first molding structure at the first side of the first layer.

Embodiments according to the invention comprise a method for manufacturing an optical structure, wherein the method comprises forming a first layer of the optical structure, wherein forming the first layer comprises forming and curing a first curable material on a first molding structure in order to form the first layer, so that, at a first side of the first layer, at which the first layer adjoins the first molding structure, a first optical lens surface is formed. The method further comprises providing a second layer of the optical structure at a second side, opposite to the first side, of the first layer, while the first layer adjoins the first molding structure at the first side of the first layer.

Providing the second layer may be or may comprise a forming of said second layer, for example, based on a molding procedure. In other words, the second layer may hence be created or established opposite to the first side of the first layer. In other words, the step of providing of the second layer may comprise an active forming or an active creation (e.g. a putting in place, e.g. an arranging, e.g. a placing, e.g. a producing, e.g. a construction, e.g. a shaping) of said layer while the first layer adjoins, or—to be more precise—still adjoins the first molding structure at the first side of the first layer.

The inventors recognized that a stack of layers of an optical structure, manufactured by molding processes, can also be, during manufacture, processed on a rear side opposite to one subject to a first molding step, namely by using the molding structure used for the first molding step at the time of processing the rear side, thereby avoiding any additional substrate at the rear side. That is, the molding structure may comprise an uneven, for example, non-planar surface for forming or replicating a first optical lens surface of a first layer of the optical structure at a first side of the first layer. At the opposite second side of the first layer, at least one processing step may be performed while the first molding structure has not yet been removed so as to function, quasi, as kind of handle. For example, this processing may involve a replication of another layer. For example, a second layer may be provided at this second side without any substrate in between the first and second layer. Hence, as an example, the second layer may be provided directly on the first layer, or the two layers may optionally only be separated by one or more coating layers. For this manufacturing step, the first layer still adjoins the first molding structure and hence, a stable basis for a precise application of the second layer and/or the one or more coating layers can be provided.

The inventors recognized that this way, a low complexity manufacturing of optical structures can be provided without the need of intermediate substrates. For example, for mechanical reasons, substrates as used in conventional approaches are bound to minimum thicknesses, which oppose a desired miniaturization of the optical structure. In simple words, the inventors recognized that the molding structure, which may, for example in conventional approaches, be needed anyway in order to form a lens surface, may be used twin fold not only for the lens forming, but as a substitute substrate as well. Hence, in addition, less elements for the manufacturing process may be needed, thereby reducing the costs.

According to embodiments of the invention, providing the second layer comprises forming and curing a second curable material at the second side of the first layer, using a second molding structure, in order to form the second layer, so that at a second side of the second layer, at which the second layer adjoins the second molding structure and which faces away from the second side of the first layer, a second optical lens surface is formed, and so that the second optical lens surface is aligned with the first optical lens surface and an optical axis of the optical structure.

In simple words, and as an example, the inventors recognized that the approach for the forming of the first optical lens surface can be mirrored for the forming of the second optical lens surface by “sandwiching” the layer stack comprising the first and second layer in between the first molding structure and the second molding structure. Hence, it is possible to form optical lens surfaces on opposite surfaces of the layer stack, namely the first side of the first layer and the second side of the second layer, without having to introduce any intermediate substrate. Again, the first molding structure may provide stability for the cured first layer at a time of the forming and curing of the second curable material.

As mentioned before, the first and second layer may adjoin each other directly. However again, it is to be noted that, for example, before providing a second layer, one or more coating layers may be provided and optionally structured on the second surface of the first layer. Optionally, such a coating layer may form a filter or an aperture or a filter combined with an aperture of the inventive projection optics or optical structure.

Accordingly, embodiments comprise projection optics, comprising a first layer of a first cured material, wherein the first layer comprises a first optical lens surface at a first side of the first layer at an optical axis of the projection optics and a planar portion at a second side of the first layer, opposite to the first side of the first layer, at the optical axis. The projection optics further comprises a second layer of a second cured material, wherein the second layer comprises a planar portion at a first side of the second layer at the optical axis and a second optical lens surface at a second side of the second layer, opposite to the first side of the second layer, at the optical axis.

Furthermore, the planar portion of the first layer adjoins the planar portion of the second layer at the optical axis or the planar portion of the first layer is separated from the planar portion of the second layer of (or at) the optical axis, only by the one or more coating layers.

Consequently, an inventive method may comprise the removal of the first and/or second molding structure after the curing of the first and second layer in order to provide the before-explained projection optics.

Furthermore, sandwiching or enclosing the first and second curable material in between the first and second molding structure for the manufacturing of the first and second layer allows to provide a precise alignment of the first and second optical lens surface and the optical axis of the projection optics.

In addition, according to embodiments, the projection optics may comprise a plurality of layer stacks. As explained before, a layer stack may comprise a first and second dual side replicated layer having optical lens surfaces on opposite sides. Accordingly, the projection optics may comprise a first further layer and a second further layer that may be manufactured like the first and second layer, wherein such a further layer stack may for example be bonded to the second layer at the second side of the second layer, such that the first further layer adjoins the second layer. This way, projection optics with at least two dual side replicated layer stacks comprising at least four optical elements in the form of optical lens surfaces may be provided. Hence, an inventive projection optics may be formed from a plurality of modules comprising first and second layers wherein the modules may be produced in a similar manufacturing process, which may reduce costs and complexity of a respective manufacturing method.

It is to be noted that in between such further layers, further coating layers may be provided as well. With regard to any of the coating layers, the inventors recognized that such coating layers may provide apertures and/or filters, in order to further increase a functional density of the projections optics or optical structure respectively.

According to further embodiments, the projection optics may comprise a third layer of a third cured material, wherein the third layer adjoins the second layer at the second side of the second layer and at a first side of the third layer, or wherein the third layer adjoins the second further layer at a second side of the second further layer and at a first side of the third layer. In addition, the third layer may comprise a third optical lens surface at a second side, opposite to the first side, of the third layer at the optical axis of the projection optics.

Accordingly, for the provision of such a third layer, an inventive method may comprise removing the second molding structure from the second layer and forming and curing a third curable material at the second side of the second layer between the second layer and a third molding structure in order to form the third layer, so that, at a first side of the third layer, the third layer adjoins the second layer, and at a second side of the third layer, which faces away from the first side of the third layer, and at which the third layer adjoins the third molding structure, a third optical lens surface is formed, and so that the first optical lens surface is aligned with the third optical lens surface at an optical axis of the optical structure.

Accordingly, a third layer may be provided on a second further layer of an inventive projection optics or optical structure.

Hence, in an inventive manufacturing process, further layers may be stacked upon first and second layers. Therefore, in simple words, one of the molding structures may be removed, so that the next curable material can be applied upon the layer and formed using a next molding structure. In simple words, for the forming of the next layer, e.g., such a third layer, the layer stack may again be sandwiched in between the first molding structure and the next, e.g., third molding structure.

In general, embodiments according to the invention may allow to use a precisely clamped or fixed first molding structure for the alignment of a plurality or even all the further layers, replicated and/or bonded upon the first molding structure. This may simplify the manufacturing process and may allow for a highly precise alignment of the layers. Therefore, in addition, alignment structures may, for example be arranged besides optical axis of the projection optics or optical structure to further improve an alignment of optical elements, such as lens surfaces. Alternatively, optical alignment methods may be used.

Furthermore, embodiments may comprise compensation structures which are configured to compensate manufacturing tolerances and/or to set or to provide a focus point of the inventive structures or inventive optics. First of all, it is to be noted that in order to reduce costs, the manufacturing of the inventive optics or structures may be performed in parallel for a plurality of such devices, for example on a wafer level and/or in an array arrangement.

The inventors recognized that based on a collection of data for respective optics or structures, individual or generic compensation structures may be used for the compensation. For example by testing, parameter sets characterizing a respective structure or optics may be obtained and in case those parameters are in simple words similar for the plurality of optics or structures manufactured in parallel, a generic compensation structure which is used for each of the structures or optics may be used. On the other hand, if such an approach would yield too many rejects, for each of the optics or structures, an individual compensation structure may be manufactured and bonded to the respective optics or structure. Alternatively, out of a plurality of different compensation structures, a best matching compensation structure may be chosen for a respective inventive projection optics or structure.

According to embodiments, on a per batch base, a choice of a respective approach, namely usage of generic compensation structures or of individual compensation structures, may be made. This may allow to provide a highly optimized manufacturing process.

### BRIEF DESCRIPTION OF THE DRAWINGS

Embodiments of the present invention will be detailed subsequently referring to the appended drawings, in which:

FIGS. 1 a-c show schematic views of projection optics with additional optional features according to embodiments of the invention;

FIGS. 2 a-t show schematic side views of optical structures and components thereof visualizing a method for manufacturing an optical structure according to embodiments of the invention; and

FIG. 3 shows schematic views of another projection optics according to embodiments of the invention.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

Furthermore, for the description of embodiments a first side of an element may be opposite to a second side of the element, and the sides of consecutive elements may be oriented, such that a first side of one element adjoins a second side of another element. Hence, first sides of elements may be oriented towards a same directions and second sides of elements may be oriented towards another same direction, opposite to the orientation of the first sides. In simple words, a first side may be a top side and a second side may be a bottom side of an element.

First of all, it is to be noted that embodiments according to the invention comprise optical systems, for example in the form of projection optics and/or optical structures. Although some embodiments are discussed with regard to projection optics or to a manufacturing method for an optical structure, it is to be noted that any features, details, and functionalities of a respective projection optics and/or of manufacturing method thereof may be used in a similar or identical or equivalent fashion for an optical structure and/or a manufacturing method thereof and vice versa. Furthermore, the inventive arrangement of a first and second layer may be referred to as layer stack or as dual side replicated layer.

Furthermore, it is to be noted that in general, as used herein, an arrangement of an element at an optical axis or at the optical axis may be understood as the element being arranged laterally at the optical axis, e.g. laterally in-plane with regard to a respective layer, for example in a lateral neighborhood of the axis, e.g. in a lateral neighboring volume perpendicular to the axis.

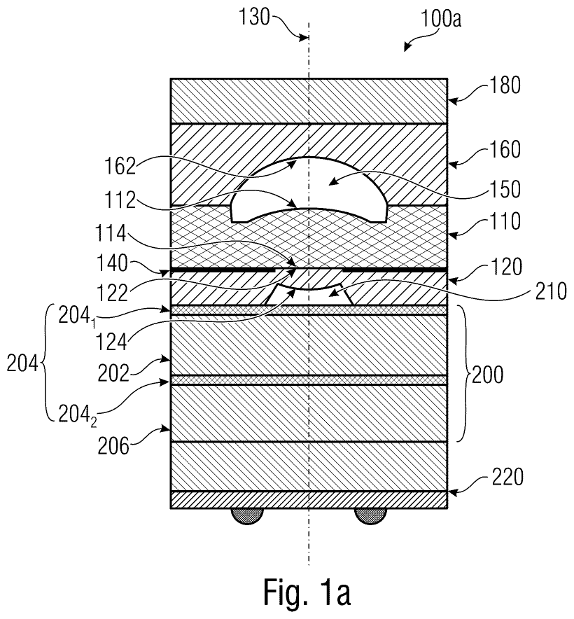

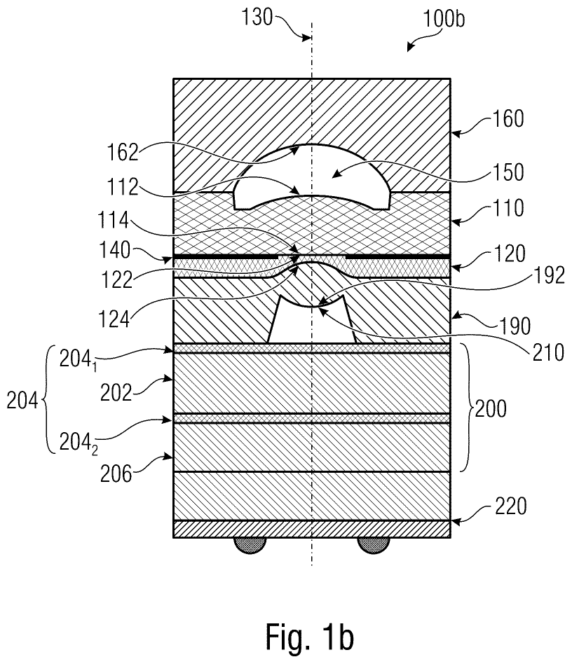

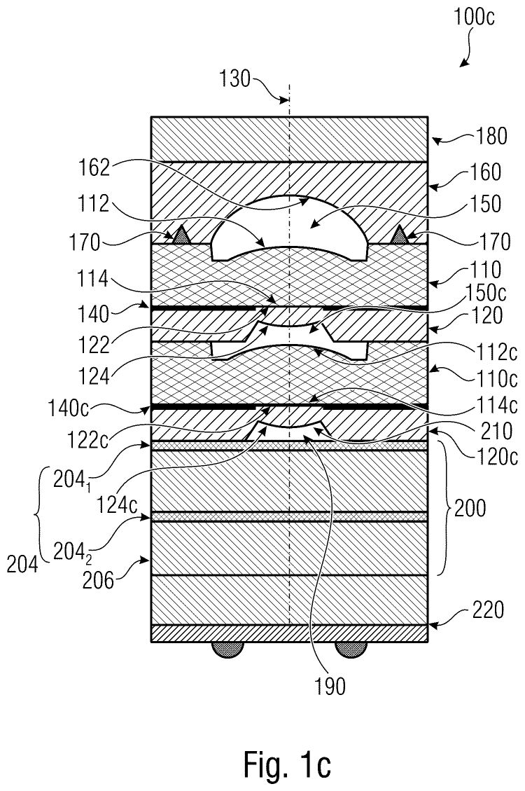

FIGS. 1a-c show schematic views of projection optics with additional optional features according to embodiments of the invention. Projection optics 100a-c each comprise a first layer 110 of a first cured material and a second layer 120 of a second cured material. The first layer 110 comprises a first optical lens surface 112 at a first side of the first layer at an optical axis 130 of the projection optics. Furthermore, the first layer 110 comprises a planar portion 114 at a second side of the first layer, opposite the first side of the first layer, at the optical axis 130. Vice versa, the second layer 120 comprises a planar portion 122 at a first side of the second layer at the optical axis 130 and a second optical lens surface 124 at a second side of the second layer, opposite to the first side of the second layer, at the optical axis 130. As shown in FIGS. 1a-c, the planar portion 114 of the first layer optionally adjoins the planar portion 122 of the second layer at the optical axis 130.

However, as an optional feature, projection optics 100a to 100c each comprise a coating layer 140. It is to be noted that more than one coating layer 130 (or 140) may be arranged in between the first layer 110 and the second layer 120. As shown in FIGS. 1a-c, coating layer 140 may be a structured coating layer. In the shown embodiments, a respective coating layer 140 may form an aperture of a respective projection optics 100a to 100c.

As another optional feature, the coating layer or the one or more coating layers may form a filter of a respective projection optics and/or an aperture and a filter of a respective projection optics. Hence, at the optical axis, the one or more coating layers, for example in the case of a filter, may be arranged in between the first layer 110 and a second layer 120, such that the planar portion 114 of the first layer 110 is separated from the planar portion 122 of the second layer 120 at the optical axis 130 only by the one or more coating layers (not shown). It is to be highlighted that in such a case, the coating layer does not have to be a filter as previously mentioned as an example, the coating layer may, for example, be just any thin layer suitable for providing any desired functionality for the projection optics.

As explained before, the layer stack comprising layers 110 and 120 may be produced with small dimensions, since in contrast to the conventional approaches, no substrate is arranged in between the first and second layer such that the layer stack may be miniaturized. Beyond that, the inventors realized that even an additional coating layer may be arranged in between the first and second layer, hence, in simple words, not only getting rid of a substrate, which would enlarge the whole setup, but additionally including another functional layer, for example, providing the functionality of an aperture or a filter or even both, with, for example, only minor impact on the dimensions of the projection optics.

As an optional feature, projection optics 100c comprises a second layer stack or in other words, a second dual side replicated layer. Projection optics 100c comprises a first further layer 110c of a first further cured material and a second further layer 120c of a second further cured material. The first further layer 110c comprises a first further optical lens surface 112c at a first side of the first further layer at the optical axis 130 of the projection optics and a planar portion 114c at a second side of the first further layer, opposite to the first side of the first further layer, at the optical axis 130. The second further layer 120c comprises a planar portion 122c at a first side of the second further layer at the optical axis 130 and a second further optical lens surface 124c at a second side of the second further layer, opposite to the first side of the second further layer, at the optical axis 130.

Furthermore, the planar portion 114c of the first further layer 110c adjoins the planar portion 122c of the second further layer 120c at the optical axis 130. Again, it is to be noted that this direct adjoining, as already explained in the context of the first and second layer, is only optional. As another optical feature, a further coating layer 140c, arranged in between the first further layer 110c and the second further layer 120c, is shown. Again, this further coating layer 140c may, for example, be a structured layer, but may optionally as well or alternatively form a filter.

In general, coating layers according to the embodiments of the invention may, for example, be any thin layer comprising any suitable functionality. Hence, again, as explained in the context of the first and second layer, the first further layer 100c may, for example, be separated from the second further layer 120c only by the coating layer 114c (or 140c) at the optical axis. Hence, instead of the planar portions 114c and 122c directly adjoining at the optical axis 130, in between these planar portions the further coating layer 140c may be arranged at the optical axis 130.

Moreover, as shown for projection optics 100c, the first further layer 110c adjoins the second layer 120 at the second side of the second layer and at the first side of the first further layer.

It is to be noted that first and second layers and first and second further layers may for example be similar, identical, or completely different layer stacks. It is to be further noted that such a set up allows the provision of a plurality of optical lens surfaces without having to include a conventional substrate. Hence, even complex optical projection paths through the projection optic 110c may be provided, without having to significantly increase the size of the projection optics.

For completeness, it is to be noted that more than one further coating layer 140c may be arranged in between the first and second further layer. In addition, it is to be noted that such a further layer stack may as well be bonded to any additional, e.g. third layer, which may be arranged on the second layer 120.

As shown, as another optional feature, projection optics 100c comprises a cavity 150c between the second optical lens surface 124 and the first further optical lens surface 112c, at the optical axis 130.

As another optional feature projection optics 100a to 100c each comprise an additional layer 160 of an additional cured material adjoining the first layer 110 at the first side of the first layer and at a second side of the additional layer. Furthermore, the additional layer comprises an additional optical lens surface 162 at the second side of the additional layer at the optical axis 130 of the projection optics. Optionally, as shown between the first optical lens surface 112 and the additional optical lens surface 162 at the optical axis 130 a cavity 150 may be present.

For example, for a bonding of the additional layer 160 to the first layer 110 an inventive projection optics may optionally comprise alignment structures. As an example, alignment structures 170 are shown in FIG. 1c. In order to further underline that this feature is only optional, the alignment structures 170 are only shown in FIG. 1c, however, they may as well be present in projection optics 100a and 100b. As shown in FIG. 1c, the alignment structures 170 may, as an example, be arranged at the first side of the first layer 110 and at the second side of the additional layer 160. The alignment structures 170 are configured to align the first layer 110 and the additional layer 160, so that the first optical lens surface 112 is aligned with the additional optical lens surface 162 at the optical axis 130. As an example, the alignment structures 170 are shown as little pyramid structures, however any form suitable for an alignment of the two layers (or any other two layers that are bonded) may be used. As an example, one of the two layers, either the first layer or the additional layer may comprise the alignment structure 170 and the respective other layer may comprise a negative form or in simple words a hole in the shape of the alignment structure, so that after bonding of the two layers the optical lens surfaces are aligned.

It is to be underlined that embodiments are not limited to such alignment structures. In an inventive manufacturing method layers may, for example, be aligned using optical alignment methods. Furthermore, alignment clamps may as well be arranged at outer borders of respective layer stacks in order to provide the alignment. Furthermore, it is to be noted that an alignment may, for example, be performed on a wafer level or on an array level for the manufacturing of the projection optics, such that a plurality of inventive devices manufactured may be aligned simultaneously. Hence, to sum up, optical alignment with alignment structures and/or with mechanical, for example clamping, structures may be performed.

As shown in FIGS. 1a and 1c, the projection optics may optionally comprise a support structure 180 adjoining the additional layer 160 at a first side, opposite to the second side, of the additional layer. The support structure 180 may, for example, be a substrate or a molding structure and/or a molding structure with a planar topology. Hence, the additional layer may, for example, be manufactured in a conventional manufacturing process on a substrate, for example a glass substrate, and the whole structure comprising the additional layer 160 and the substrate may then be bonded on the first layer 110. However, instead of using a substrate a molding structure may be used for the manufacturing of the additional layer 160. Hence, on a first side of the additional layer 160, optionally another lens surface may be arranged, formed by a respective molding structure. As another optional feature the support structure 180 may be a molding structure with a planar topology, in simple words acting as a substrate.

As another optional feature, as shown in FIG. 1b, projection optics 100b comprises a third layer 190 of a third cured material. The third layer adjoins the second layer 120 at the second side of the second layer at a first side of the third layer. Furthermore, the third layer 190 comprises a third optical lens surface 192 at a second side, opposite to the first side, of the third layer at the optical axis 130 of the projection optics. For example, in a projection optics as shown in FIG. 1c, optionally the third layer may adjoin the second further layer 120c (not shown) at the second side of the second further layer and at a first side of the third layer.

Projection optics 100b as shown in FIG. 1b may provide the functionality of an achromat. Hence, optionally two consecutive layers of the projection optics may comprise different optical characteristics, namely in the example shown in FIG. 1 b) second layer 120 and third layer 190. Hence, an optical lens surface of a first of the two consecutive layers may comprise a high refractive index and low dispersion and an optical lens surface of a second of the two consecutive layers, facing towards the optical lens surface of the first of the two consecutive layers may comprise a low refractive index and high dispersion, in order to form the achromat. Hence, embodiments according to the invention may allow to limit the effect of chromatic and spherical aberrations. Neighboring lens surfaces may hence provide the functionality of a flint glass and a crown glass.

As another optional feature as shown in FIGS. 1a-c, projection optics 100a-c may comprise a backside structure 200 and a cavity 210. As shown in FIG. 1a, a first surface of the backside structure 200 may adjoin the second layer 120 at the second side of the second layer and the cavity 210 may be arranged between the backside structure 200 and the second optical lens surface 124 at the optical axis 130. Alternatively, as shown in FIG. 1b, a first surface of the backside structure 200 may adjoin the third layer 190 at the second side of the third layer and the cavity 210 may be arranged between the backside structure 200 and the third optical lens surface 192 at the optical axis 130. As another optional alternative, as shown in FIG. 1c, a first surface of the backside structure 200 may adjoin the second further layer 120c at the second side of the second further layer and the cavity 210 may be arranged between the backside structure 200 and the second further optical lens surface 124c at the optical axis 130.

The backside structure may provide mechanical stability to the projection optics. Optionally, as shown in FIGS. 1a-c, the backside structure may comprise a backside substrate 202, a filter 204 and a compensation structure 206. The compensation structure 202 (or 206) may be configured to compensate manufacturing tolerances and to set or to improve a focus point of the optical structure. As a result of manufacturing the layers of the projection optics, for example, a thickness thereof, may vary within certain tolerances. However, this may deteriorate a desired beam path through the projection optics and may hence, for example, worsen a desired alignment of rays through the projection optics on a predetermined focus point, for example, at a position where a sensor is bonded to the projection optics. In order to compensate for such tolerances, the compensation structure 202 (or 206) may be included in the projection optics.

As shown, the filter 204 optionally comprises a first filter structure 204₁ arranged on a first surface of the backside substrate 202 and a second filter structure 204₂ arranged on a second surface, opposite to the first surface, of the backside substrate 202. The double-sided application of the filter structures may allow a compensation of warping effects during manufacturing, such that backside substrate 202 and filter 204 may form a planar structure that may be precisely bonded to the other layers and/or elements of the projection optics.

For reference, the compensation structure 206 may comprise a first surface and a second surface, wherein the second surface is opposite to the first surface and, as shown in FIGS. 1a-c, the first surface of the compensation structure may adjoin the second filter structure 204₂ such that the first filter structure 204₁ forms the first surface of the backside structure 200.

However, it is to be noted that according to embodiments, an order of compensation structure and backside substrates together with a filter is interchangeable. Hence, optionally (not shown), the first filter structure 204₁ may adjoin the second surface of the compensation structure 202 (or 206), such that the first surface of the compensation structure forms the first surface of the backside structure 200. Simply speaking, the backside substrate and filter comprising the filter structures may, for example, be arranged at the bottom and the compensation structure 202 (or 206) at the top of the backside structure 200.

In addition, it is to be noted that according to embodiments the backside structure 200 may optionally comprise only the compensation structure 206 or only the backside substrate 202 together with the filter 204.

In addition, it is to be noted that the filter may optionally only comprise the first filter structure and no second filter structure. The first filter structure may be arranged on the first surface of the backside substrate at least at the optical axis. Hence, the first filter structure and the first surface of the backside substrate may form the first surface of the backside structure. In other words, a filter material may only be arranged and structured on the backside substrate at an area around, e.g. laterally around, the optical axis. Hence, the first filter structure may only partially form the first surface of the backside structure.

Furthermore, in general, it is to be noted that the cavity 210 may at least be partially formed by at least one of a recess in the second layer, a recess in the second further layer, a recess in the third layer, a recess in the backside structure, a through hole in the backside structure, and/or a through hole in a compensation structure of the backside structure. A recess and/or a through hole may be manufactured by at least one of etching, powder blasting and/or laser induced deep etching, LIDE. Hence, the cavity may be provided based on a forming of spacer structures using a respective molding structure, in order to provide a cavity for a respective lens structure and/or based on a recess or a through hole in the backside structure. It is to be noted that the cavity may be provided by one of the before mentioned techniques or both. Accordingly, a respective lens structure, may find place in the recess or through hole in the backside structure, for example, in case the respective layer does not comprise a recess in which the lens structure is arranged.

Furthermore, it is to be noted that a through hole in the backside structure may be a though hole through a component of the backside structure, such as the compensation structure. Hence, with a subsequent filter, the though hole may be “closed” on one side, forming a cavity or a portion of a cavity. In addition, a cavity may be understood as a “closed” cavity, wherein an inner volume of the cavity is fully sealed from an environment but as well as an “open” cavity, such as a natural cavity with an entrance, or in other words a cavity which is not fully closed from an environment.

Optionally, the compensation structure 206 may be a generic compensation structure which is configured to compensate manufacturing tolerances and/or to set or to improve a focus point of a plurality of projection optics on average. In a batch manufacturing process of a plurality of projection optics measurement results of the plurality of projection optics may be obtained in order to obtain appropriate dimensions for the compensation structure 206. For example, in case different projection optics are similar, for example with respect to their tolerances, generic compensation structures may be formed and may be equally used for all the projection optics. Hence, the compensation structures used may be configured to compensate (at least partially or approximately) the manufacturing tolerances and/or to set or to improve the focus points of the plurality of projection optics at least on average. In other words, the compensation structures may be formed as, in simple words, a compromise to best improve the plurality of projection optics.

Accordingly, the compensation structures 206 may as well be individual compensation structures which are configured to compensate manufacturing tolerances and/or to set or improve the focus point of the projection optics. Hence, for example based on individual measurements of respective projection optics, for each projection optic an individual compensation structure may be formed to best improve the characteristics of the respective optics.

Optionally, projection optics 100a, 100b and 100c may comprise a lateral size, in plane to the first layer 110, of at least 100 μm or of at least 200 μm or of at least 300 μm or of at least 0.5 mm and of at most 2 mm or of at most 3 mm or of at most 5 mm. Alternatively or in addition, the projection optics may comprise a height, orthogonal to the first and second layer, of at least 0.5 mm or of at least 1 mm or of at least 2 mm and of at most 2 mm or of at most 3 mm or of at most 5 mm. Hence, as mentioned before, projection optics with small dimensions may be provided. This may allow usage for challenging applications, such as providing visual support for surgeries inside the human body.

As another optional feature FIGS. 1a-c show a sensor structure 220 bonded to the compensation structure 206. Hence, using compensation structure 206 rays traveling through the projection optics may be focused precisely on a sensor chip of the sensor structure 220.

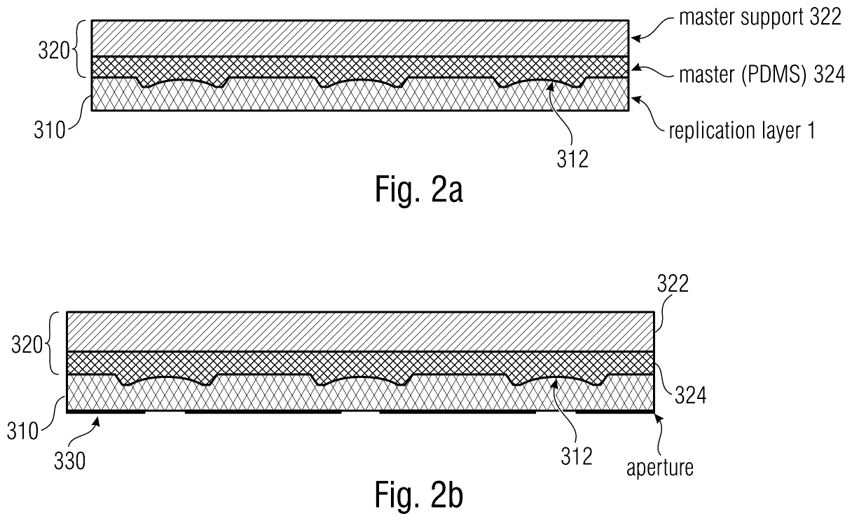

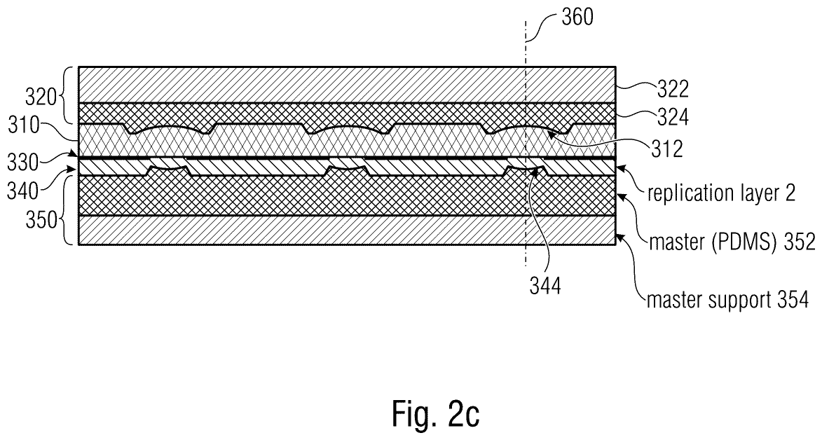

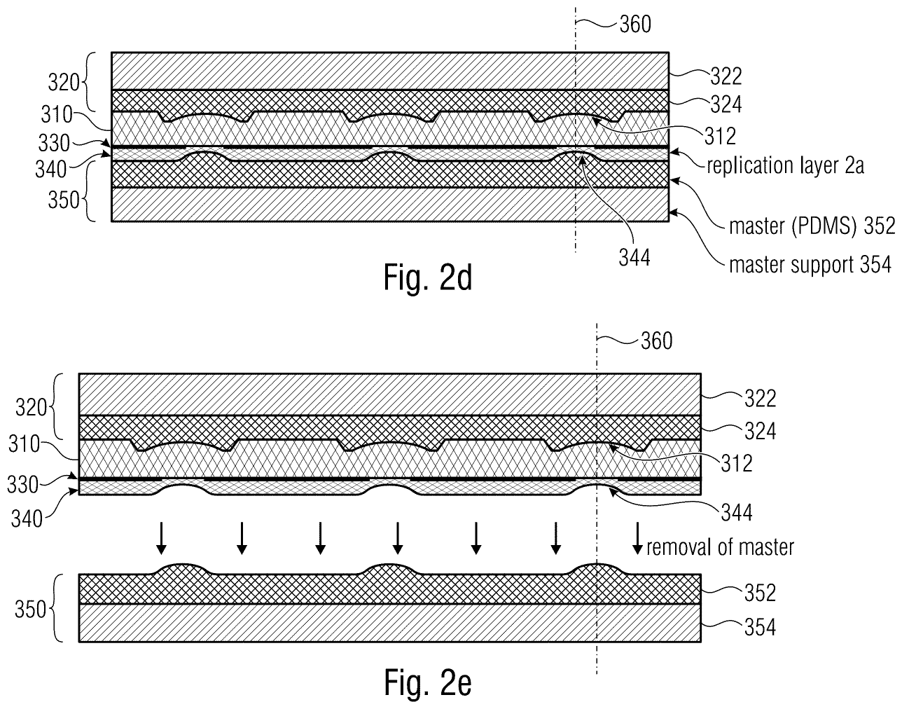

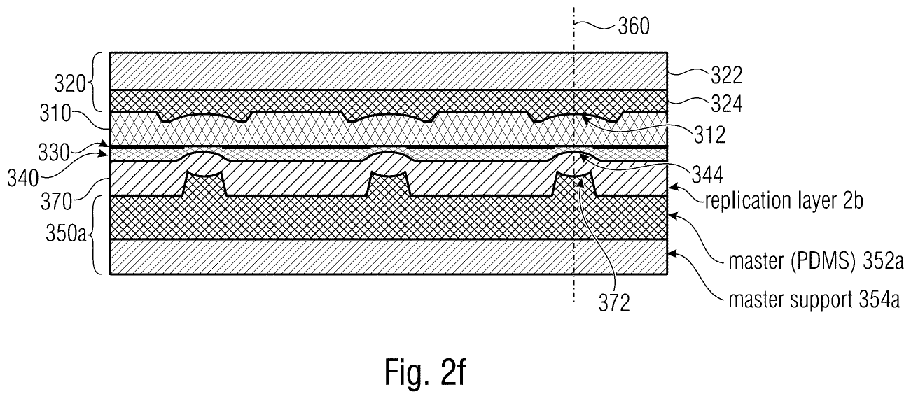

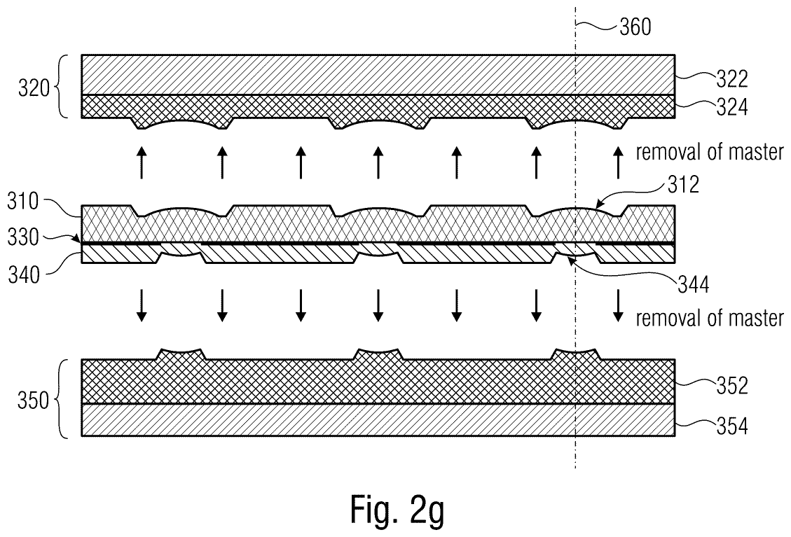

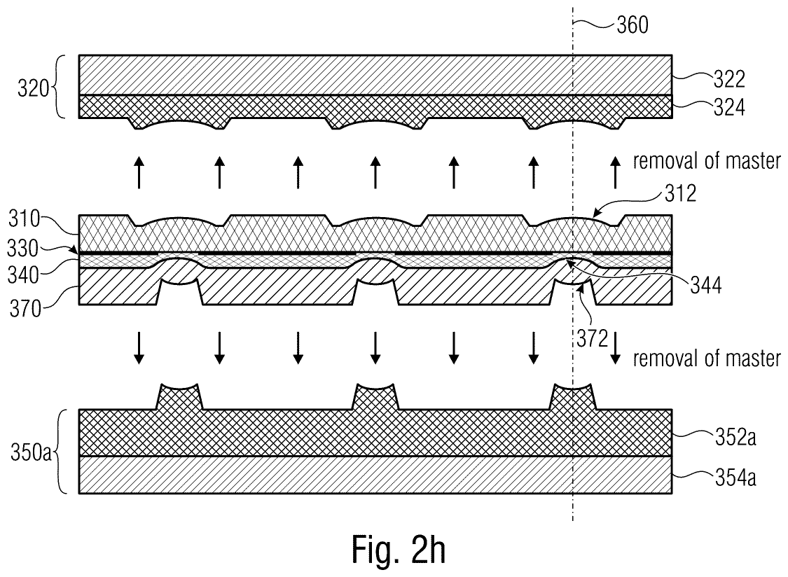

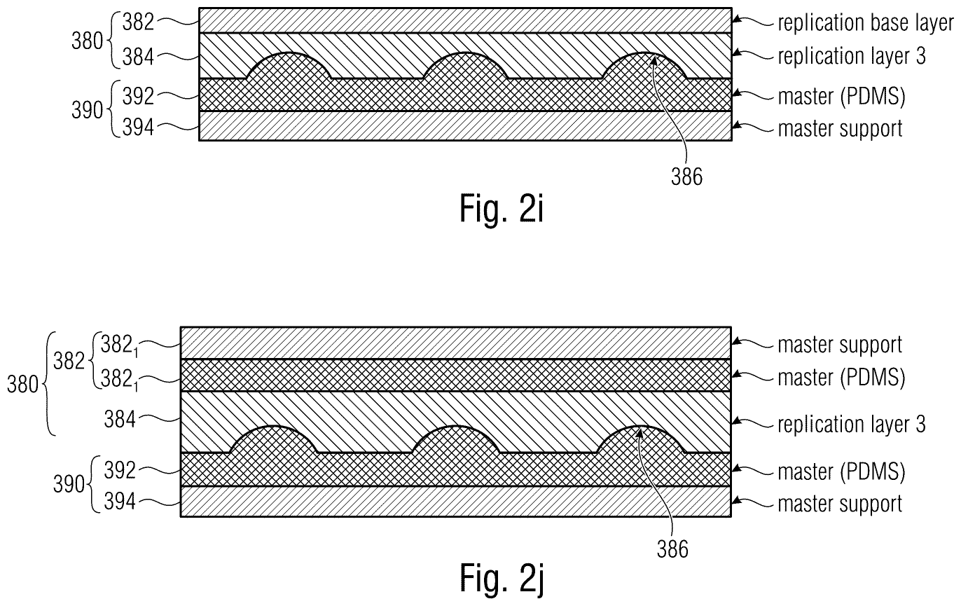

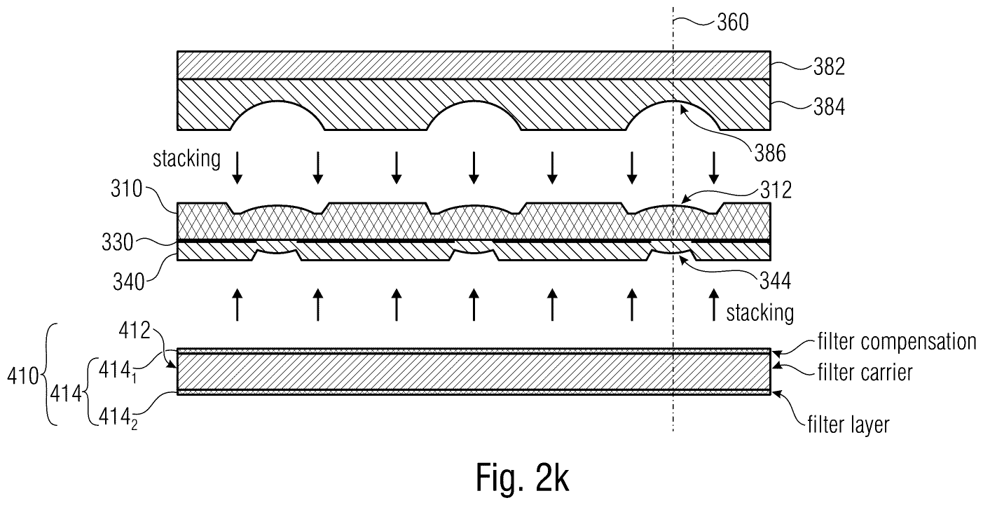

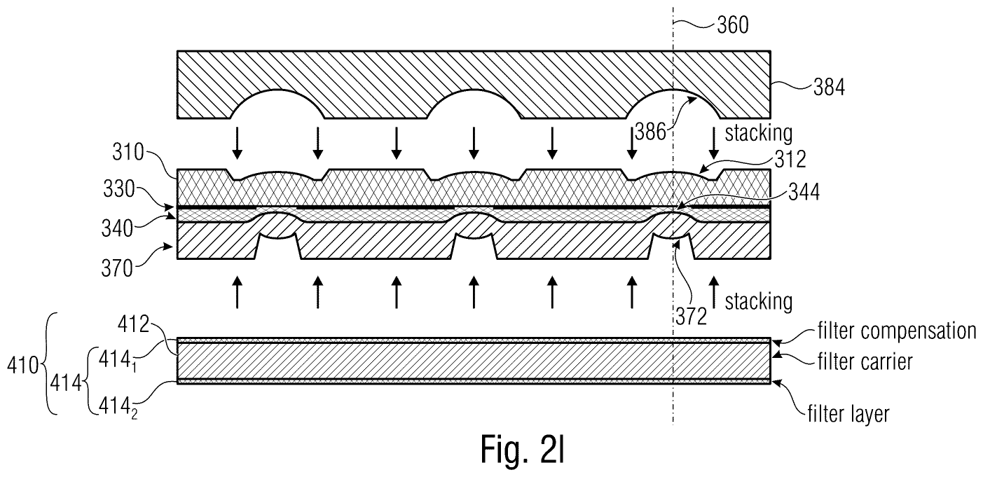

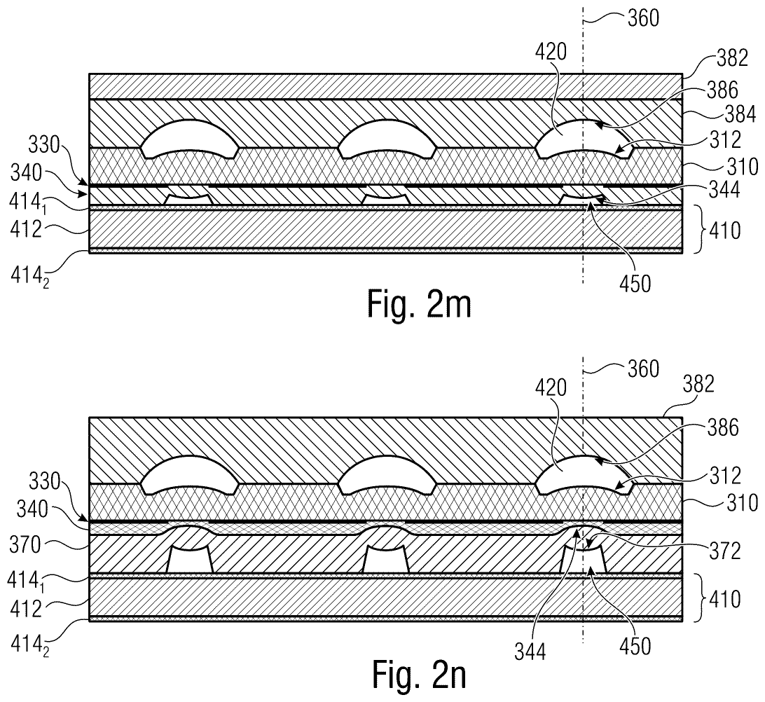

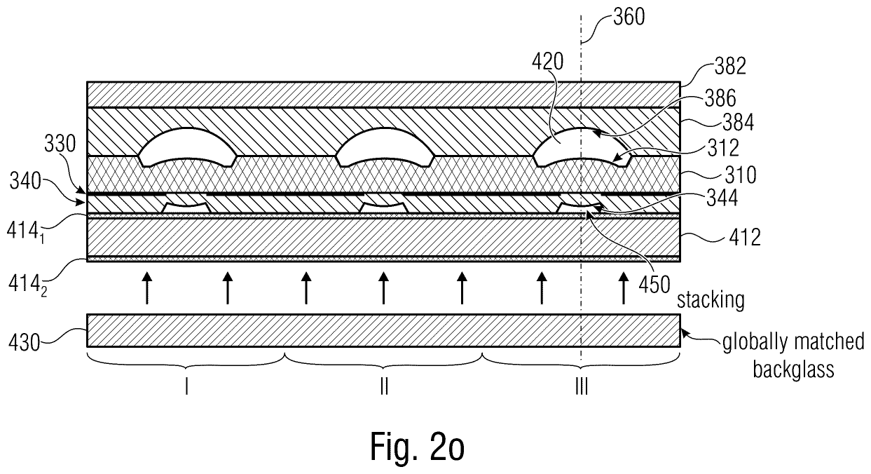

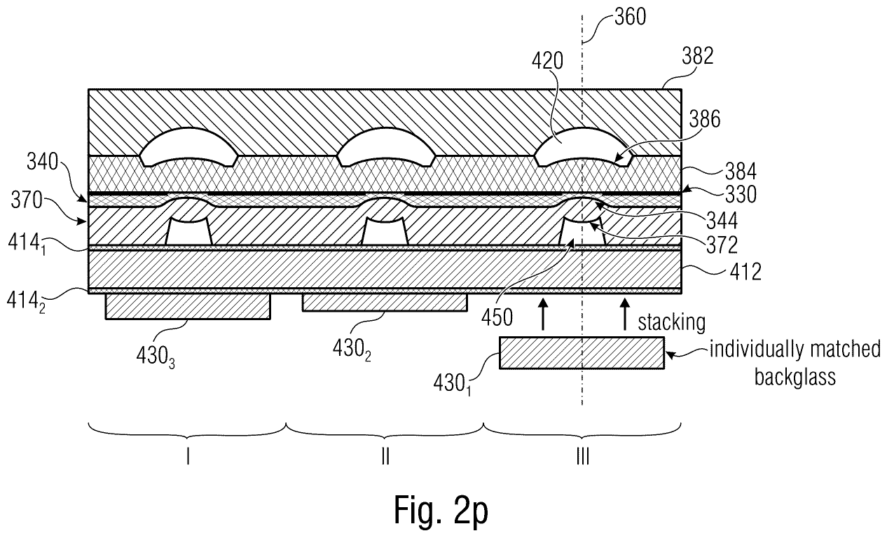

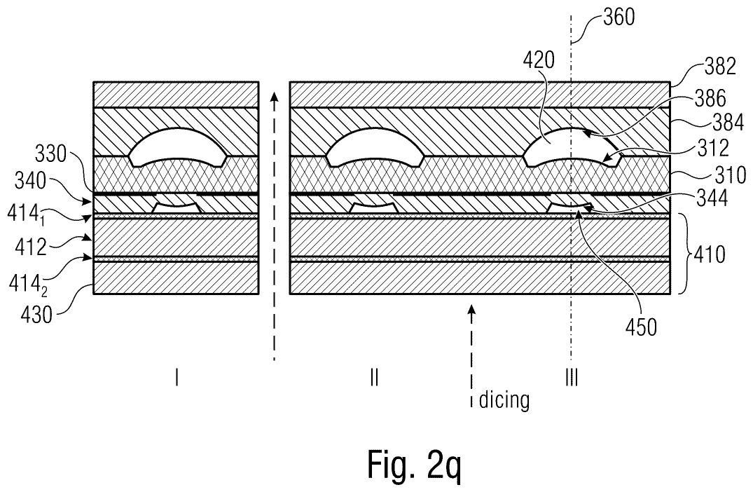

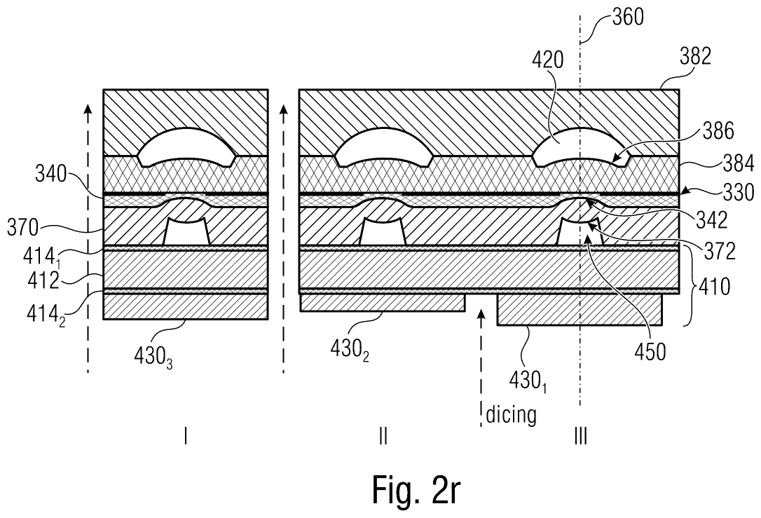

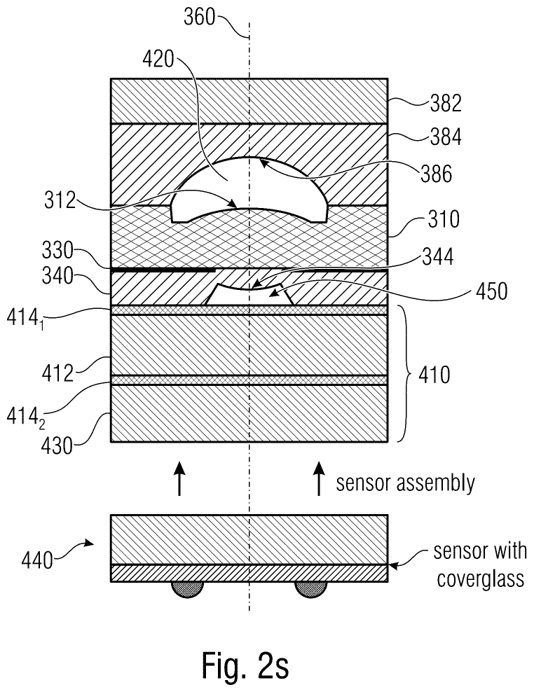

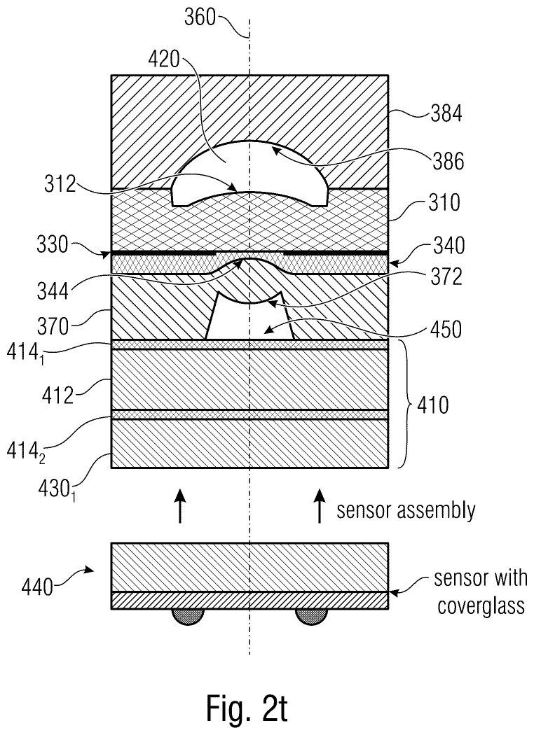

In the following, reference is made to FIG. 2a to t. FIG. 2 shows schematic side views of an optical structure and components thereof and visualizes a method for manufacturing an optical structure according to embodiments of the invention. The optical structure manufactured may, for example, be the projection optics as shown in FIG. 1.

FIGS. 2a-d show the forming of a first layer of the optical structure and a provision of a second layer of the optical structure. As shown in FIG. 1a, a first layer 310 may be formed wherein the forming of the first layer comprises forming and curing a first curable material on a first molding structure 320 in order to form the first layer, so that, at a first side of the first layer, at which the first layer adjoins the first molding structure, a first optical lens surface 312 is formed.

Optionally, as shown in FIG. 2b, a method according to embodiments may comprise providing one or more coating layers between the first layer 310 and a second layer. Therefore, as shown in FIG. 2b, a coating layer 330 may be arranged on a planar surface of the first layer 310 at the second side of the first layer 310. As another optional feature the one or more coating layers 330 may be structured. As an example, as shown in FIG. 2b, the one coating layer 330 forms an aperture. However, it is to be noted that apart from an aperture the one or more coating layers may optionally form a filter and/or a filter and an aperture.

It is to be noted that provision of the coating layer is performed at a second side, opposite to the first side, of the first layer 310, wherein the first layer 310 adjoins the first molding structure 320 at the first side of the first layer.

As shown in FIG. 2c, a second layer of the optical structure may be provided at a second side, opposite to the first side, of the first layer 310, again, while the first layer 310 adjoins the first molding structure 320 at the first side of the first layer. As shown in FIG. 2c, a second molding structure 350 may be used for the forming of the second layer, however, it is to be noted that this feature is only optional.

Hence, as shown in FIG. 2c, providing the second layer 340 may comprise forming and curing a second curable material at the second side of the first layer 310 using the second molding structure 350 in order to form the second layer, such that at a second side of the second layer 340 at which the second layer adjoins the second molding structure 350 and which faces away from the second side of the first layer 310, a second optical lens surface 344 is formed, and so that the second optical lens surface 344 is aligned with the first optical lens surface 312 at an optical axis 360 of the optical structure. As shown in FIG. 2c, the second optical lens surface 344 may be a convex lens but alternatively, as shown in FIG. 2d, a concave shape may be provided as well. Hence the molding structure 350 as shown in FIG. 2d may comprise a different form.

As optionally shown, a respective molding structure may comprise a master support 322 and 354, respectively, and a master (PDMS) 324 and 352, respectively. The master support may, for example, comprise or be made out of glass and the master may comprise polydimethylsiloxane. In the embodiment as shown in FIGS. 2a-t, the first layer 310 may be a first replication layer and the second layer 330 may be a second replication layer. Replication layer 2 and replication layer 2a may hence be different examples for the second layer 330 differing in the shape of the respective optical lens surfaces 344.

Hence, in other words, referring to FIG. 2a according to embodiments, a first process step can be to replicate lens layer 1, e.g., replication layer 1, using the master 324 (e.g. typical PDMS type material) including a master support 322 (for example typical glass). The replication layer may be applied by a paddling process and may be UV cured afterwards. As an example, such a paddling process may comprise applying an epoxy material, e.g. replication layer 1, on a substrate or wafer, or according to embodiments to a molding structure, e.g. by a mechanical “paddle” to reach a final thickness of the material. Furthermore, the paddling process may comprise moving away the excess of the material with the paddle.

As another example, a spin coating may be performed for the above process step.

Referring to FIG. 2b, as an example and in other words, in this process step the replicated layer may still be kept in the master 324, and a coating layer 330 in the form of an aperture may be applied by coating a thin layer of, for example, opaque black material (that can, for example, be lithographically structured), e.g., by spin coating, that can be structured by a lithographic process, to generate the coating layer in the form of the apertures. It is to be noted that in contrast to conventional approaches wherein the aperture is structured on a glass substrate with typical black chromium, according to embodiments, the aperture may be structured directly on the replication layer.

Referring to FIG. 2c, as an example and in other words, in this process step the replication layer (including the structured aperture) may be still kept in the master and then the replication layer 2 (lens 2, e.g., layer 340 comprising second optical lens surface 344) is replicated by using a second master 352 (including master support 354).

As shown in FIG. 2, an inventive method according to embodiments may be performed in order to provide a plurality of optical structures, for example on a wafer level or in array arrangement. Hence, as shown, a plurality of optical lens surfaces 312 and 344 may be provided (see e.g. later dicing step shown in FIG. 2 q)). Therefore, later on in the process the layers may be diced in order to provide the plurality of optical structures. In this regard, it is to be noted that although wafer level lenses may be done, no glass substrate may be used between replication layer 1 and 2 and replication layer 2 may be replicated directly on the aperture and on replication layer 1.

Referring to FIG. 2d, in other words and as an example, FIG. 2d may show an alternative approach, e.g., alternative to the approach as shown in FIG. 2c, where the replication layer 2 is no longer a convex lens but comprises a concave shape (replication layer 2a) in order to be able to build an achromat. Lens layer 2a, for example (e.g. second layer 340), may comprise a relatively low abbe number (e.g. V-number or constringence of a transparent material) and may represent the flint type material.

Referring to FIGS. 2e and f, as another optional feature, a third layer 370 of the optical structure may be provided. As shown in FIG. 2e, the providing of the third layer 370 may comprise removing the second molding structure 350 from the second layer 340 and forming and curing a third curable material at the second side of the second layer 340 between the second layer and a third molding structure 350a (again optionally comprising a Master 352a and a Master support 354a), as shown in FIG. 2f, in order to form the third layer, so that at a first side of the third layer 370, the third layer adjoins the second layer 340, and at a second side of the third layer, which faces away from the first side of the third layer, and at which the third layer adjoins the third molding structure 350a, a third optical lens surface 372, as shown in FIG. 2f, is formed, and so that the first optical lens surface 312 is aligned with the third optical lens surface 372 at the optical axis 360 of the optical structure.

As shown, optionally the third layer 370 may be provided while the first layer 310 adjoins the first molding structure 320 at the first side of the first layer.

In other words, referring to FIG. 2e, in this step the master 352 that was forming the concave lens, e.g., lens surface 344 as shown in FIG. 2d, is removed, but the whole wafer is still kept in the master 324 from lens 1.

It is to be noted that manufacturing steps of FIGS. 2e and 2f are shown on the basis of the approach as shown in FIG. 2d. However, the provision of the third layer may as well be performed for an optical structure as shown in FIG. 2c or any other alternative layer stack according to an embodiment of the invention.

Again, to put it in other words and as an example, referring to FIG. 2f, to complete the alternative approach, e.g., as shown in FIG. 2d, and to build an achromat, another layer (replication layer 2b, e.g., comprising a double convex shape) may be over coated on the replication layer 2a in order to be able to build the achromat. Lens layer 2b, for example, (e.g. third layer 370), may comprise a relatively high abbe number and may represent the crown type material which may be needed to build an achromat and to improve chromatic aberrations. Hence, in summary, embodiments comprise the building of an achromat on a wafer level optics, e.g. especially in comparison to conventional approaches.

As another optional feature, the steps as visualized in FIGS. 2a-d may be used in order to provide and to form a first and second further layer. Hence, in a similar or identical fashion, a further layer stack may be provided wherein forming the first further layer of the optical structure comprises forming and curing a first further curable material on a first further molding structure in order to form the first further layer, so that, at a first side of the first further layer, at which the first further layer adjoins the first further molding structure, a first further optical lens surface is formed. Furthermore, providing the second further layer of the optical structure at a second side, opposite to the first side of the first further layer, while the first further layer adjoins the first further molding structure at a first side of the first further layer, may comprise forming and curing a second further curable material at the second side of the first further layer, using a second further molding structure, in order to form the second further layer, so that at a second side of the second further layer, at which the second further layer adjoins the second further molding structure and which faces away from the second side of the first further layer, a second further optical lens surface is formed, and so that the second further optical lens surface is aligned with the first further optical lens surface at the optical axis of the optical structure.

Hence, in simple words, in the steps as shown in FIG. 2a-d, layer 310 may represent the first further layer. Layer 340 may represent the second further layer, first molding structure 320 may represent the first further molding structure, and molding structure 350 may represent the second further molding structure.

It is to be noted that accordingly, one or more further coating layers may be provided between the first further layer and the second further layer and that at least one of the one or more further coating layers may be structured. In addition, as explained in the context of the one or more coating layers, the one or more further coating layers may hence form an aperture and/or a filter, or both at the same time.

In this regard, it is to be noted that a thickness of a coating layer of the one or more coating layers and/or of the one or more further coating layers, in between the first and second layer and in between the first and second further layer respectively may comprise at most 10% or at most 5% or at most 2% or at most 1% of the thickness of the first layer or of the thickness of the second layer and/or of the thickness of the first further layer and/or of the thickness of the second further layer respectively.

The second layer stack comprising the first and second further layer may hence be bonded to the first layer stack comprising the first and second layer. Therefore, e.g., as shown in FIG. 2e, the second molding structure 350 may be removed. In addition, (not shown), for the bonding, the first further molding structure may be removed. Then, (not shown), the first further layer may be bonded to the second layer 340, so that the first further layer adjoins the second layer at a second side of the second layer and at the first side of the first further layer and, so that the first further optical lens surface is aligned with the second optical lens surface 344 at the optical axis 360 of the optical structure. Accordingly, as explained in the context of FIG. 1c, the first further optical lens surface and the second optical lens surface may be formed, so that the optical structure comprises a cavity between the first further optical lens surface and the second optical lens surface at the optical axis of the optical structure. Again, it is to be noted that the further layer stack may as well be bonded to a third layer of the optical structure.

FIG. 2g shows another optical process step according to embodiments, wherein, for example, as a next step for the structure as shown in FIG. 2c, the first and second molding structures 320 and 350, may be removed. In other words, a next process, for example in a case wherein the optical structure is not an achromat, may be to remove the master wafer on both sides.

FIG. 2h shows an example of a further optical method step, for example for the structure as shown in FIG. 2f, comprising the removal of the first and third molding structures 320 and 350a. In other words, a next process step on the alternative approach (achromat) may be to remove the master wafer on both sides.

However, it is to be noted that the removal of respective molding structures may be performed one after another. FIGS. 2i and 2j show the additional optional method step of providing an optical substructure. The optical substructure 380 comprises a support structure 382 and an additional layer 384. Providing the optical substructure may comprise forming and curing an additional curable material between an additional molding structure 390 and the support structure 382 in order to form the additional layer 384, so that, at a second side of the additional layer 384 at which the additional layer adjoins the additional molding structure 390 an additional optical lens surface 386 is formed, and so that the additional layer adjoins the support structure 382 at a first side of the additional layer, which is opposite to the second side of the additional layer.

Again, the additional molding structure 390 may optionally comprise a master 392 and a master support 394. Furthermore, the additional layer may be, as shown, a replication layer, namely replication layer 3 and in the same way the support structure may be a replication base layer.

As shown in the example of FIG. 2i, the support structure may be a substrate. Alternatively, as shown in FIG. 2j, the support structure 382 may be a molding structure and/or e.g., as specifically shown in FIG. 2j, a molding structure with a planar topology. As another optional feature, in FIG. 2j, the planar molding structure again comprises a master support 380₁ and a master 382₂.

Referring to FIG. 2i, as an example and in other words, in this process step, the lens replication layer 3 may be made by replication directly on a glass substrate, e.g., in the form of the replication base layer, and using master 392 (PDMS) and master support 394.

Accordingly, in other words and referring to FIG. 2j, FIG. 2j may show an alternative approach where no substrate (front glass) is used to replicate lens layer 3, e.g., replication layer 3, but just a master support 382₁ including a flat PDMS layer 382₂. As an example, the lens layer, e.g. 384, may be replicated by using a Master, e.g. 392, with layer 3 structure and Master support, e.g. 394.

Afterwards, as an optional feature, both masters 382 and 390 may be removed, e.g. as shown in Figs. g) and h) (e.g. FIGS. 2 g) and h)). Hence, embodiments may comprise optical structures without a cover glass in the final product, but having a substrate-less design.

As shown as an optical and/or optional feature in FIGS. 2k and 2l, at least after the removal of the first molding structure 320 from the first layer 310, for example as shown in FIGS. 2g and 2h, and after removing the additional molding structure 390, the additional layer 384 may be bonded to the first layer 310, so that the additional layer 384 adjoins the first layer 310 at the first side of the first layer and at a second side of the additional layer and, so that the additional optical lens surface 386 is aligned with a first optical lens surface 312 at the optical axis of the optical structure. As optionally shown in FIG. 2l, an inventive method may further comprise the removal of the support structure 382 from the additional layer 384. It is to be noted that the removal of the support structure is irrespective of a form of the structure, hence the support structure may be removed in the form of a glass substrate or a substrate, or in the form of the molding structure or even in the form of a planar molding structure, e.g., as shown in FIG. 2j.

As another optional feature as shown in FIG. 2k, a method according to embodiments may comprise a bonding of a first surface of a backside structure 410 to the second layer 340 at a second side of the second layer, so that the second optical lens surface 344 and the first surface of the backside structure form a cavity 450 (as shown in FIG. 2m). As shown in FIG. 2g, for the bonding of the backside structure 410, the method may comprise removing the second molding structure 350 from the second layer 340, e.g., beforehand.

Accordingly, as shown in FIG. 2l, in the case of an optical structure comprising a third layer 370, the third molding structure 380, e.g., as shown in FIG. 2h, may be removed and a first surface of the backside structure 410 may be bonded to the third layer 370 at a second side of a third layer so that the third optical lens surface 372 and the first surface of the backside structure form a cavity 450 (as shown in FIG. 2n).

As optionally shown in FIGS. 2k and 2l, the backside structure 410 may comprise a substrate 412 and a filter 414. The filter may comprise a first filter structure 414₁ arranged on a first surface of the backside substrate and a second filter structure 414₂ arranged on a second surface, opposite to the first surface of the backside substrate. Hence, the first filter structure 414 may form the first surface of the backside structure 410.

Referring to FIG. 2k, to put it in other words, the backside substrate 412 may be or may act as a filter carrier and layer 414₁ may be a filter compensation or a filter compensation layer and layer 414₂ may be a filter layer. As explained before, a double sided application of a filter layer may mitigate warping effects and may allow provision of a flat backside structure 410 that may be bonded precisely to the respective layer 340 or 370. Furthermore, as an example and in other words, when lens layers 1, 2, and 3 are finished, they may be stacked and bonded together, and then a backside glass, e.g., 410, may be bonded that can, for example, just be glass, wherein the thickness may for example be well-defined with low TTV (low total thickness variation).

Hence, in general, embodiments according to the invention may comprise backside structures comprising only a backside substrate as well. The backside glass, e.g., 410, can have an optical filter, e.g., 414, integrated, e.g., an NIR cut filter, notch filter, band pass filter, etc. As explained before, in order to not get any or only limited or little warpage on the filter substrate, the filter may be applied on both sides, so that there is a compensation and a substrate stays flat. Referring to FIG. 2l, a same or similar process as shown in FIG. 2k may be shown, but now with the alternative approach of lens 1, 2a/b and lens 3 (achromat).

The results of stacking steps as shown in FIGS. 2k and 2l are shown in FIGS. 2m and 2n. As shown, optionally, the first optical lens surface 312 and the additional optical lens surface 386 may be formed so that the optical structure comprises a cavity 420 between the first optical lens surface and the additional optical lens surface at the optical axis 360 of the optical structure.

As an example and in other words, FIG. 2m may show a final bonded stack still in wafer format, and FIG. 2n may show a final bonded stack still in wafer format (alternative achromat approach).

FIGS. 2o and 2p show further optional features of a method according to embodiments, wherein the optical structure is provided with a compensation structure 430 and respectively 430₁, 430₂ and 430₃. The compensation structure may be configured to compensate manufacturing tolerances and/or to set or to improve a focus point of the optical structure. In addition, the backside structure 410 may comprise the compensation structure.

Therefore, the respective compensation structure may be bonded to the first and/or second filter structure. As explained before, in simple words, the order of compensation structure and substrate 412 and filter 414 may be changed. Hence, as alternatives, an inventive method may optionally comprise bonding the first filter structure to the second surface of the compensation structure, so that the first surface of the compensation structure forms the first surface of the backside structure 410, such that the compensation structure is bonded to the second or respectively third layer or, for example, second further layer. Alternatively, an inventive method may optionally comprise bonding the first surface of the compensation structure on the second filter structure 414₂, so that the first filter structure 414₁ forms the first surface of the backside structure 410, e.g., as shown in FIGS. 20 and 2p.

However, it is to be noted that the backside structure 410 may, for example, only comprise the compensation structure 430 or respectively 430₁, or only elements 412 and 414.

As shown in FIG. 2o, the compensation structure may be a generic compensation structure, which is used for each of the optical structures of a set of optical structures. As shown in FIG. 2o, the compensation structure 430 may, for example, hence be a globally matched backglass. Optionally, the method may further comprise determining a plurality of sets of parameters, each set of parameters characterizing an optical structure of a plurality of optical structures and providing the compensation structure as a generic compensation structure. The providing of the compensation structure may further comprise adjusting the compensation structure based on the plurality of sets of parameters determined in order to compensate manufacturing tolerances and to set or to improve a focus point of the optical structures on average.

As shown in FIG. 2o and as mentioned earlier, a separation into a plurality of optical structures, here as an example for the sake of simplicity into three different optical structures, I, II, and III, may be performed. It is to be noted that in general, according to embodiments, a large number of structures, e.g. hundreds or thousands or tens of thousands of optical structures or projection optics or lens stacks may be arranged in one row, e.g. of a wafer or of an array arrangement. In other words in reality, the drawing may just show a section of three structures out of typical much more (on a 8″ wafer could be easily 10.000 structures or maybe 100) in one row.

Hence, for each of these stacks, measurements may be performed and as an example, in case respective characteristics of the stacks, that may be diced into distinct optical structures, may be similar enough (e.g. with regard to yield or performance) in order to use the generic structure, such that manufacturing tolerances are compensated on average (e.g., to allow for a “compromise compensation” for the three optical structures I, II, III).

Accordingly, e.g., as shown in FIG. 2p, in case those layer stacks that may be diced into the individual optical structures I, II, III are not similar enough or the approach of an, e.g., globally matched backglass, may yield too many defective devices, based on respective measurements and/or sets of parameters characterizing a respective optical structure, individual compensation structures 430₁, 430₂, and 430₃ may be provided wherein the respective individual compensation structures are adjusted based on a respective set of parameters, in order to compensate manufacturing tolerances and/or to set or to improve a focus point of a respective optical structure.

In other words, and as an example, referring to FIG. 2o, in order to compensate for tolerances and to build up a camera where the best focus position is well defined, there may be a need of adding an additional glass spacer wafer (e.g., compensation structure 430). For example all lenses on the stacked wafer or array arrangement may be measured regarding MTF, (modulation transfer function), BFL (back focal length), EFL (effective focal length), etc., for example with an automated test system and a wafer map or an array map, for the plurality of optical structures, may be generated. In case the tolerances of sets of parameters, e.g. of BFL, within a wafer or array is not too big, the approach of a globally matched back glass may be used, meaning that, for example, the mean value of all lenses or layer stacks, on a wafer or within an array of optical structures, regarding BFL may be calculated, and the compensation structure, e.g., back glass wafer may be grinded to that thickness. Lenses (e.g., layer stacks I, II, and/or III) that have a bad MTF, or where the BFL is too short or even much too short or too long or even way too long, then may not or would not be used and yield may or will drop.

Hence, referring to FIG. 2p, in case tolerances are too high when using globally matched back glasses and yield may not be acceptable, alternatively, individual spacer matching can be used. Again, all lenses on the stacked wafer may be measured regarding characterizing parameters, e.g. MTF, BFL, EFL, etc., e.g., with an automated test system, and a wafer or array map may be generated. A set of already diced compensation structures with predefined dimension, e.g., glass substrates, e.g., 430₁, 430₂, 430₃, may or will be prepared that have different, e.g. well-defined thicknesses (e.g., a plurality, for example 5 different ones with specific differences), and then those small glass substrates may be single piece bonded to the individual lens stack. As an example, a shorter BFL may need a thinner backglass, etc. For example, typically, at the end, just lenses that have bad MTF may need to be skipped.

However, it is to be noted that embodiments are not limited to compensation structures in the form of glass spacers. A compensation structure according to embodiments may as well be another replication layer, e.g. a layer comprising an epoxy material that may be applied and UV cured afterwards. In particular, such a compensation layer may be applied on a wafer level, hence before a dicing into separate projection optics. As discussed before, a testing (e.g. with regard to the full aperture of respective optics) of the projection optics may be performed on a wafer level, for example individually for each projection optics or so as to obtain a single result for the projection optics of the whole wafer.

Optionally, according to embodiments of the invention, the compensation structure may be adapted according to such a testing, for example on a wafer level, so as to set or to improve a back-focal length of the projection optics of the wafer. This may correspond to a global setting of a focal length or focal lengths of the projection optics of the wafer. Therefore, a thickness of the compensation structure may be adjusted, for example over the whole wafer, for example, so that the compensation structure comprises a same thickness over the whole wafer. Alternatively, individual adaptations may as well be performed.

Using the inventive manufacturing approach, the focal length of the projection optics of a wafer may be set with good accuracy, e.g. with low individual tolerances from one projection optics of the wafer to another. This may allow performing a global adaptation of the compensation structure, e.g. instead of individually adapted spacers, in order to fine-tune a focal length within a set tolerance.

Hence, in general, according to embodiments, the compensation layer may be of a cured material (e.g. first, second, further and/or another cured material) and may be configured to compensate manufacturing tolerances and/or to set or to improve a focus point of the projection optics and/or to set or to improve a focus point of a plurality of projection optics on a wafer level.

Accordingly, optionally, the backside structure 410 may comprise a backside substrate 412, a filter 414 and a compensation structure, wherein the compensation structure is configured to compensate manufacturing tolerances and/or to set and/or to improve a focus point of the optical structure, wherein the filter comprises a first filter structure 414₁ arranged on a first surface of the backside substrate, wherein the filter comprises a second filter structure 414₂ arranged on a second surface, opposite to the first surface, of the backside substrate, or wherein the filter comprises a first filter structure arranged on a first surface of the backside substrate at least at the optical axis, and wherein the first filter structure and the first surface of the backside substrate form the first surface of the backside structure.

Furthermore, the method optionally comprises bonding the first filter structure 414₁ to the second layer at the second side of the second layer so that the second optical lens surface and the first filter structure 414₁ form a cavity at the optical axis; or bonding the first filter structure 414₁ to the second further layer at the second side of the second further layer so that the second further optical lens surface and the first filter structure 414₁ form a cavity at the optical axis, or bonding the first filter structure 414₁ to the third layer at the second side of the third layer so that the third optical lens surface and the first filter structure 414₁ form a cavity.

In addition the method may optionally comprise forming and curing a curable material on the second filter structure 414₂ or on the backside substrate, in order to form the compensation structure, e.g. as explained before with a predefined thickness to compensate manufacturing tolerances and/or to set a focal length of respective optics.

As another optional feature, a method according to embodiments may comprise forming and curing a curable material on a substrate and/or molding structure, in order to form the compensation structure, removing the compensation structure from the substrate and/or molding structure and bonding the compensation structure to the second layer at the second side of the second layer so that the second optical lens surface and the compensation structure form a cavity at the optical axis; or bonding the compensation structure to the second further layer at the second side of the second further layer so that the second further optical lens surface and the compensation structure form a cavity at the optical axis, or bonding the compensation structure to the third layer at the second side of the third layer so that the third optical lens surface and the compensation structure form a cavity.

Optionally, the method may comprise forming and curing a curable material on a substrate and/or molding structure, in order to form the compensation structure, removing the compensation structure from the substrate and/or molding structure and bonding the compensation structure to the second filter structure or to the backside substrate.

As an example, the globally matched backglass may hence be, in simple words, replaced by a globally matched cured material.

Referring to FIGS. 2q and 2r, a method according to embodiments may optionally comprise performing a dicing in order to separate optical structures I, II, and III of the plurality of optical structures. In other words and as an example, after e.g., everything, is finished, the whole wafer or array may be diced, for example, with a wafer saw using blue tape or UV release tape. FIG. 2q shows an example using a globally matched back glass 430, shown in FIG. 2r are, as an example, individually matched back glasses for the alternative approach (achromat).

As shown in FIGS. 2s and 2t, an inventive method may optionally comprise a bonding of a sensor structure 440 to the optical structure. As shown, the sensor may comprise a cover glass. In other words and as an example, once the optic stack is finished, a CMOS image sensor may be bonded to the lens. FIG. 2t may show the alternative approach with the achromat.

FIGS. 1a) and 1b) may show the final results of a manufacturing method according to FIGS. 2 a) to s) and t) respectively. Hence, in accord with the embodiments as explained in the context of FIG. 2, in FIGS. 1 a) and b) layer 110 may be Replication Layer 1, layer 120 may be Replication Layer 2 (in FIG. 1a)) and respectively Replication Layer 2a (in FIG. 1b)), layer 180 may be the Replication Base Layer, layer, 160 may be Replication Layer 3, coating layer 140 may be the Aperture, layer 190 in FIG. 1b) may be a Replication Layer 2b, element 202 may be a filter carrier, with element 204₁ being a filter compensation and element 204₂ being a filter layer, with element 206 being a matched spacer and with element 220 being a sensor with coverglass.

Hence, FIG. 1 a) may show a final product with 3 aspheric surfaces and one aperture, and with no substrate between layer 1 and 2 and with a substrate on replication layer 3 (which may also act as a cover glass). FIG. 1b) may show a final product with 4 aspheric surfaces (2a and 2b, for example, acting as an achromat) and one aperture, with no substrate between layer 1 and 2a/b and no substrate on replication layer 3.

In general, it is to be noted, that embodiments according to the invention may comprise aspheric and/or spheric optical lens surfaces. In other words and as an example, all lens surfaces, e.g. as shown, may typically have aspheric shape, but could also be spheric depended on the concrete design. Furthermore, as explained before, a process according to embodiments can be in wafer format e.g. 6″, 8″ or 12″ round substrates, but also square or rectangular substrates are possible. As an example, a typical size of a final product can be around 1 mm×1 mm and 2 mm height, and pitch between lenses of e.g. 1.4 mm.

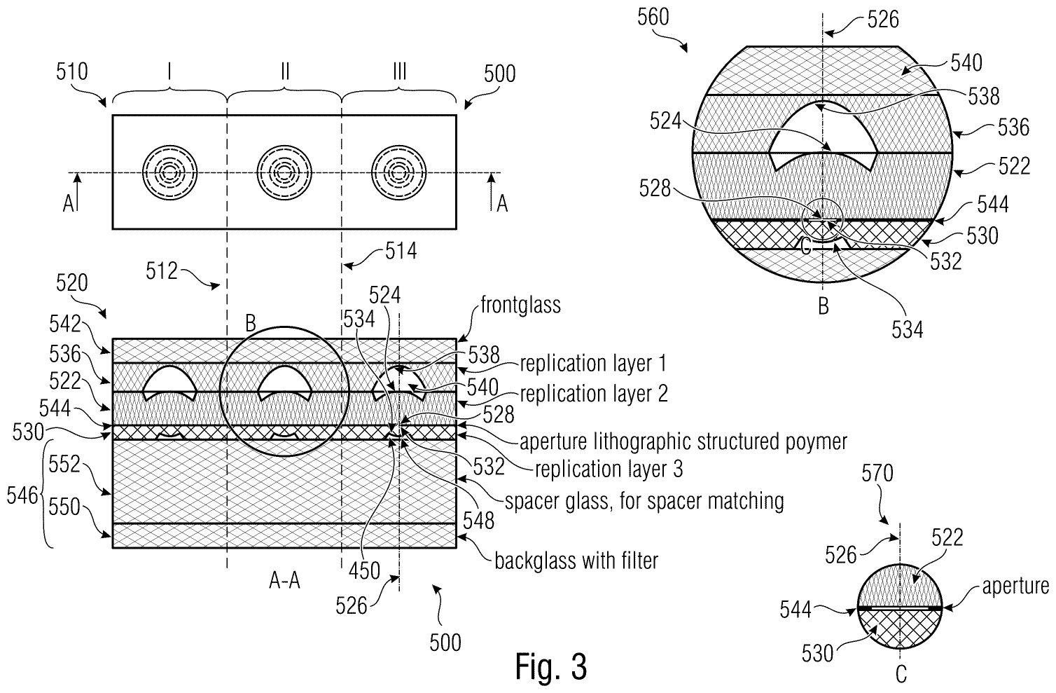

FIG. 3 shows schematic views of another projection optics according to embodiments of the invention. FIG. 3 shows a schematic top view 510 of a plurality of projection optics I, II and III in a wafer level or array level arrangement. As an example, respective projection optics may be diced along the dashed lines 512, 514.

Furthermore, FIG. 3 shows a schematic side view 520, along section plane A-A, as shown in schematic top view 510. As explained before, the projection optics 500 (III) comprises a first layer 522 of a first cured material, as an example, in the form of an replication layer (Replication Layer 2), comprising a first optical lens surface 524 at a first side of the first layer at an optical axis 526 of the projection optics and a planar portion 528 at a second side of the first layer, opposite to the first side of the first layer, at the optical axis. The projection optics 500 (III) further comprises a second layer 530 of a second cured material in the form of another replication layer (Replication Layer 3), comprising a planar portion 532 at a first side of the second layer at the optical axis 526, and a second optical lens surface 534 at a second side of the second layer, opposite to the first side of the second layer, at the optical axis 526.

As an optional feature, the projection optics 500 comprises an additional layer 536 of an additional cured material adjoining the first layer 522 at the first side of the first layer and at a second side of the additional layer. Furthermore, the additional layer comprises an additional optical lens surface 538 at the second side of the additional layer at the optical axis 526 of the projection optics and a cavity 540 between the first optical lens surface 524 and the additional optical lens 538 at the optical axis.

Furthermore, as another optional feature, the projection optics comprises a support structure 542 adjoining the additional layer at a first side, opposite to the second side, of the additional layer, wherein the support structure is a substrate in the form of a front glass.

Moreover, the projection optics 500 comprises a lithographically structured coating layer 544 (e.g. from a polymer material) in the form of an aperture.

As another optional feature, projection optics 500 comprises a backside structure 546 and a cavity 548, wherein a first surface of the backside structure adjoins the second layer 530 at the second side of the second layer and the cavity 548 is arranged between the backside structure 546 and the second optical lens surface 534 at the optical axis 526.

As an example, the backside structure 546 comprises a backside substrate with a filter 550 in the form of a back glass with filter and a compensation structure 552 in the form of a spacer glass, for spacer matching. As explained before, the compensation structure is configured to compensate manufacturing tolerances and/or to set or to improve a focus point of the optical structure.

The filter comprises a first filter structure arranged on a first surface of the backside substrate and a second filter structure arranged on a second surface, opposite to the first surface, of the backside substrate. The compensation structure comprises a first surface and a second surface, wherein the second surface is opposite to the first surface.

In the example shown in FIG. 3 the first filter structure adjoins the second surface of the compensation structure, such that the first surface of the compensation structure forms the first surface of the backside structure.

FIG. 3 further shows an enlarged schematic side view 560 of a section B as shown in view 520, highlighting the layer setup. In addition, FIG. 3 shows an enlarged schematic side view 570 of a section C as shown in view 560, further highlighting the thin, structured coating layer 544 in between the first and second layer.

Furthermore, embodiments according to the invention comprise miniaturized wafer level cameras.

Embodiments according to the invention comprise miniaturized wafer level cameras with wide field of view comprising or for example consisting of a first glass substrate (e.g. 180 (FIG. 1); e.g. 540 (FIG. 3)) which is in direction of the object, followed by a replicated epoxy layer (e.g. layer 160 (FIG. 1); e.g. layer 382 (FIG. 2); e.g. layer 536 (FIG. 3)) with first lens (e.g. 162 (FIG. 1); e.g. 386 (FIG. 2); e.g. 538 (FIG. 3)) with a concave aspherical surface that is in direction of the sensor side. This epoxy layer can, for example, also have integrated posts/spacers around the lens, so that the next layer can be stacked on top. As an example a corresponding molding structure, e.g. an additional molding structure may comprise posts spacers (e.g. posts/spacers) in order to form a cavity (e.g. 150 (FIG. 1), e.g. 420 (FIG. 2), e.g. 540 (FIG. 3)) in between lens surfaces. The first lens is followed by a replicated second lens (e.g. layer 110 (FIG. 1); e.g. layer 310 (FIG. 2); e.g. layer 522 (FIG. 3)) which has a convex aspherical surface (e.g. 112 (FIG. 1); e.g. 312 (FIG. 2); e.g. 524 (FIG. 3)) and comprises or, for example, consists of Epoxy only. Optionally, once this second lens wafer (e.g. layer 110 (FIG. 1); e.g. layer 310 (FIG. 2); e.g. layer 522 (FIG. 3)) is replicated, at the flat surface there may or will be structured a black material, in general a coating layer (e.g. 140 (FIG. 1); e.g. 330 (FIG. 2); e.g. 544 (FIG. 3)), that can optionally be structured by photolithographic process and so an aperture can be formed. As next step on top of the aperture the third lens (e.g. layer 120 (FIG. 1); e.g. layer 340 (FIG. 2); e.g. layer 530 (FIG. 3)) which comprises or is another convex aspheric lens structure (e.g. 124 (FIG. 1); e.g. 344 (FIG. 2); e.g. 534 (FIG. 3)) may, or will be replicated. Both replicated convex surface layers can, for example, also have the posts integrated so that the wafers can be bonded together (for example, such that respective cavities (150 and 210 (FIG. 1); 420 and 450 (FIG. 2); 540 and 450 (FIG. 3)) are formed).

This may also be one of the fundamental differences to conventional approaches, e.g. as shown in US2017031089A, where they are using a glass substrate to replicate Lens 2 and Lens 3 on (e.g. in comparison to the example shown in FIG. 3), or in most of the claims also two glass substrates where the aperture is structured in the middle of both glass substrates.

Another way of optimizing the performance of the lens design (and/or to provide an alternative lens design) may be to split lens 3 into two, meaning to create an achromat by first replicating a lens 3a (e.g. as shown with Replication layer 2a in FIG. 2) which has a concave surface, and that lens material having refractive index of for example at least 1.5 and at most 2.0, e.g. of 1.6 and low abbe number of for example less than 50 e.g. of 28 (Flint), and then overmolding a convex layer which is lens 3b (e.g. as shown with Replication layer 2b in FIG. 2) of lens material that has refractive index of for example 1.52 or lower and an abbe number of for example more than 50, e.g. of 52 (Crown).

In case the third lens will have the posts/spacers already integrated (e.g. to provide a cavity, e.g. 210 in FIG. 1c)), there can be bonded another substrate (e.g. 202 in FIG. 1, e.g. 412 in FIG. 2) e.g. a glass substrate (for example a second glass substrate). This second glass substrate can also comprise or contain a wavelength filter (e.g. 204 in FIG. 1, e.g. 414 in FIG. 2) like a NIR Cut Filter. One option is to put the filter layers on both sides of the second glass substrate, e.g. to compensate for stress and/or thermal mismatch and minimize wafer warpage. Another option is to apply the filter on the second glass wafer only at the side to the object, but, for example, not over the full wafer area, but structured and applied just at the areas where it is optically needed.

Another option is that glass substrate 2 is consisting of or comprises an etched cavity in direction of the third lens. In that case, the replicated third lens layer does not need to have or may not need to have the posts/spacers integrated, for example, because the lens finds space in the cavity of the glass. But also, both sides (third lens layer and etched cavity in the glass) can optionally be integrated and act as spacers.

Another way to create the spacer is to use a glass spacer that has through holes integrated, that through holes can, for example, be manufactured by etching, powderblasting and/or by LIDE (Laser induced deep etching).

Spacers can be also manufactured by replicating spacer structure on top of a glass substrate.

Once the whole optical stack is bonded together an image sensor can be attached. The image sensor may have or may comprise a cover glass which may be bonded directly to the image sensor surface. Since the image sensor may need per pixel microlenses for fillfactor enhancement and crosstalk minimization before applying the cover glass to the sensor on wafer level there may be or will be coated a transparent material with low refractive index (low-n material), so that even if those microlenses are fully covered with material, they are still optically functional. On top of the low n material there may be glued the cover glass, which may then be glued to the optic stack.

Furthermore, according to embodiments, as an optional feature, a curable material may, for example, be any material suitable for the forming of a layer, e.g. replication layer. As an example, the material may, for example, be curable by UV-light (or in general by radiation) and/or for example by heat, for example via a processing with a defined temperature profile.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Projection optics comprising:
a first layer of a first cured material,
wherein the first layer comprises a first optical lens surface at a first side of the first layer at an optical axis of the projection optics, and
wherein the first layer comprises a planar portion at a second side of the first layer, opposite to the first side of the first layer, at the optical axis; and
a second layer of a second cured material,
wherein the second layer comprises a planar portion at a first side of the second layer at the optical axis, and
wherein the second layer comprises a second optical lens surface at a second side of the second layer, opposite to the first side of the second layer, at the optical axis;
wherein the planar portion of the first layer adjoins the planar portion of the second layer at the optical axis, or
wherein the planar portion of the first layer is separated from the planar portion of the second layer at the optical axis, only by one or more coating layers.

2. Projection optics according to claim 1, further comprising:
a first further layer of a first further cured material
wherein the first further layer comprises a first further optical lens surface at a first side of the first further layer at the optical axis of the projection optics, and
wherein the first further layer comprises a planar portion at a second side of the first further layer, opposite to the first side of the first further layer, at the optical axis; and
a second further layer of a second further cured material
wherein the second further layer comprises a planar portion at a first side of the second further layer at the optical axis, and
wherein the second further layer comprises a second further optical lens surface at a second side of the second further layer, opposite to the first side of the second further layer, at the optical axis;
wherein the planar portion of the first further layer adjoins the planar portion of the second further layer at the optical axis; or
wherein the planar portion of the first further layer is separated from the planar portion of the second further layer at the optical axis, only by one or more further coating layers; and
wherein the first further layer adjoins the second layer at the second side of the second layer and at a first side of the first further layer.

3. Projection optics according to claim 1,
wherein at least one of the one or more coating layers and/or of the one or more further coating layers form an aperture of the projection optics; and/or
wherein at least one of the one or more coating layers and/or of the one or more further coating layers form a filter of the projection optics; and/or
wherein at least one of the one or more coating layers and/or of the one or more further coating layers form an aperture and a filter of the projection optics.

4. Projection optics according to claim 2, the projection optics further comprising:
a cavity between the second optical lens surface and the first further optical lens surface, at the optical axis.

5. Projection optics according to claim 1, the projection optics further comprising:
an additional layer of an additional cured material adjoining the first layer at the first side of the first layer and at a second side of the additional layer;
wherein the additional layer comprises an additional optical lens surface at the second side of the additional layer at the optical axis of the projection optics.

6. Projection optics according to claim 5, further comprising:
a cavity between the first optical lens surface and the additional optical lens surface at the optical axis.

7. Projection optics according to claim 5, further comprising:
alignment structures arranged at the first side of the first layer and at the second side of the additional layer, wherein the alignment structures are configured to align the first layer and the additional layer, so that the first optical lens surface is aligned with the additional optical lens surface at the optical axis.

8. Projection optics according to claim 5,
wherein the projection optics comprises a support structure adjoining the additional layer at a first side, opposite to the second side, of the additional layer.

9. Projection optics according to claim 8,
wherein the support structure is a substrate; or
wherein the support structure is a molding structure; and/or
wherein the support structure is a molding structure with a planar topology.

10. Projection optics according to claim 1, further comprising:
a third layer of a third cured material,
wherein the third layer adjoins the second layer at the second side of the second layer and at a first side of the third layer, or
wherein the third layer adjoins the second further layer at the second side of the second further layer and at a first side of the third layer; and
wherein the third layer comprises a third optical lens surface at a second side, opposite to the first side, of the third layer at the optical axis of the projection optics.

11. Projection optics according to claim 1, the projection optics further comprising:
a backside structure and a cavity;
wherein a first surface of the backside structure adjoins the second layer at the second side of the second layer and wherein the cavity is arranged between the backside structure and the second optical lens surface at the optical axis, or
wherein a first surface of the backside structure adjoins the second further layer at the second side of the second further layer and wherein the cavity is arranged between the backside structure and the second further optical lens surface at the optical axis, or
wherein a first surface of the backside structure adjoins the third layer at the second side of the third layer and wherein the cavity is arranged between the backside structure and the third optical lens surface at the optical axis.

12. Projection optics according to claim 11,
wherein the backside structure comprises a backside substrate and a filter;
wherein the filter comprises a first filter structure arranged on a first surface of the backside substrate, wherein the first filter structure forms the first surface of the backside structure; and wherein the filter comprises a second filter structure arranged on a second surface, opposite of the first surface, of the backside substrate, or
wherein the filter comprises a first filter structure arranged on a first surface of the backside substrate at least at the optical axis, and wherein the first filter structure and the first surface of the backside substrate form the first surface of the backside structure.

13. Projection optics according to claim 11,
wherein the backside structure is a compensation structure which is configured to compensate manufacturing tolerances and/or to set or to improve a focus point of the projection optics.

14. Projection optics according to claim 11,
wherein the backside structure comprises a backside substrate, a filter and a compensation structure,
wherein the compensation structure is configured to compensate manufacturing tolerances and/or to set or to improve a focus point of the projection optics,
wherein the filter comprises a first filter structure arranged on a first surface of the backside substrate; wherein the filter comprises a second filter structure arranged on a second surface, opposite to the first surface, of the backside substrate, or
wherein the filter comprises a first filter structure arranged on a first surface of the backside substrate at least at the optical axis, and wherein the first filter structure and the first surface of the backside substrate form the first surface of the backside structure;
wherein the compensation structure comprises a first surface and a second surface, wherein the second surface is opposite to the first surface; and
wherein the first filter structure and/or the first surface of the backside structure adjoin the second surface of the compensation structure, such that the first surface of the compensation structure forms the first surface of the backside structure, or
wherein the first surface of the compensation structure adjoins the second filter structure or the second side of the backside substrate, such that the first filter structure and/or the first surface of the backside substrate form the first surface of the backside structure.

15. Projection optics according to claim 13,
wherein the compensation structure is a generic compensation structure which is configured to compensate manufacturing tolerances and/or to set or to improve a focus point of a plurality of projection optics on average; or
wherein the compensation structure is an individual compensation structure which is configured to compensate manufacturing tolerances and/or to set or to improve a focus point of the projection optics.

16. Projection optics according to claim 1,
wherein at least two consecutive layers of the projection optics comprise different optical characteristics, and
wherein an optical lens surface of a first of the two consecutive layers comprises a high refractive index and low dispersion, and wherein an optical lens surface of a second of the two consecutive layers, facing towards the optical lens surface of the first of the two consecutive layers, comprises a low refractive index and low dispersion, in order to form an achromat.

17. Method for manufacturing an optical structure, the method comprising:
forming a first layer of the optical structure, wherein forming the first layer comprises
forming and curing a first curable material on a first molding structure in order to form the first layer, so that, at a first side of the first layer, at which the first layer adjoins the first molding structure, a first optical lens surface is formed; and
providing a second layer of the optical structure at a second side, opposite to the first side, of the first layer,
while the first layer adjoins the first molding structure at the first side of the first layer.

18. Method according to claim 17, wherein providing the second layer comprises
forming and curing a second curable material at the second side of the first layer, using a second molding structure, in order to form the second layer,
so that at a second side of the second layer, at which the second layer adjoins the second molding structure and which faces away from the second side of the first layer, a second optical lens surface is formed; and
so that the second optical lens surface is aligned with the first optical lens surface at an optical axis of the optical structure.

19. Method according to claim 18, the method further comprising:
forming a first further layer of the optical structure, wherein forming the first further layer comprises
forming and curing a first further curable material on a first further molding structure in order to form the first further layer, so that, at a first side of the first further layer, at which the first further layer adjoins the first further molding structure, a first further optical lens surface is formed; and
providing a second further layer of the optical structure at a second side, opposite to the first side, of the first further layer,
while the first further layer adjoins the first further molding structure at the first side of the first further layer;
wherein providing the second further layer comprises
forming and curing a second further curable material at the second side of the first further layer, using a second further molding structure, in order to form the second further layer,
so that at a second side of the second further layer, at which the second further layer adjoins the second further molding structure and which faces away from the second side of the first further layer, a second further optical lens surface is formed; and
so that the second further optical lens surface is aligned with the first further optical lens surface at the optical axis of the optical structure; and
removing the first further molding structure; and
removing the second molding structure; and
bonding the first further layer to the second layer,
so that the first further layer adjoins the second layer at the second side of the second layer and at the first side of the first further layer, and
so that the first further optical lens surface is aligned with the second optical lens surface at the optical axis of the optical structure.

20. Method according to claim 17, further comprising:
providing one or more coating layers between the first and second layer; and/or
providing one or more further coating layers between the first further layer and the second further layer
wherein a thickness of a coating layer of the one or more coating layers and/or of the one or more further coating layers, in between the first and second layer and/or in between the first and second further layer respectively is at most 10% or at most 5% or at most 2% or at most 1% of the thickness of the first layer or of the thickness of the second layer and/or of the thickness of the first further layer or of the thickness of the further second layer respectively.
